(19) United States
(12) Patent Application Publication
(10) Pub. No.: US 2025/0031634 A1
(43) Pub. Date: Jan. 30, 2025

(54) SYSTEM AND METHOD TO OPERATE A FORESTRY MACHINE

(71) Applicant: Deere & Company, Moline, IL (US)

(72) Inventor: Sanket Pawar, Pune (IN)

(21) Appl. No.: 18/357,255

(22) Filed: Jul. 24, 2023

(51) Int. Cl. A01G 23/00

(52) U.S. Cl. CPC A01G 23/003

(57) ABSTRACT

A forestry apparatus includes a lifting linkage supported from a main frame. The lifting linkage includes a boom. At least one lifting linkage actuator adjusts the height of the boom. A grapple is suspended from the boom and includes first and second grapple tongs and a grapple actuator configured to move the grapple tongs in a closing motion from an open position toward a closed position. At least one position sensor is configured to detect positions of first and second grapple tong tips relative to the main frame or relative to the ground surface. A controller receives the at least one position signal and automatically controls the at least one lifting linkage actuator to coordinate the positions of the grapple tong tips relative to the main frame or relative to the ground surface with the closing motion of the grapple tongs.

### BACKGROUND OF THE DISCLOSURE

### Field of the Disclosure

The present disclosure relates to a forestry machine such as a skidder grapple machine or a forwarder machine, and particularly to a control system which assists in the control of the grapple while engaging and lifting a load.

### Description of the Prior Art

Skidder grapple machines are forestry work vehicles used to haul logs in rugged terrain. A set of tongs are located at the rear of the skidder grapple machine and used to grab the logs. The tongs are suspended from a boom of a lifting linkage which includes a pivoted arch supported from a main frame, and the boom pivotally supported from the arch.

While picking up logs with the tongs of the skidder grapple machine, the human operator will raise the tongs to try to avoid digging into the ground with the tongs. The proper manual adjustment of the boom and arch positions along with the tongs in order to ensure that the tongs follow the ground surface as closely as possible requires a great deal of skill.

A forwarder machine is another type of forestry work vehicle used to pick up logs and stack them in a wagon of the forwarder machine for transport. The forwarder machine also uses a grapple for picking up logs.

There is a need for improvements in the control systems of forestry machines such as skidder grapple machines and forwarder machines to aid the human operator in the operation of the grapple.

### SUMMARY OF THE DISCLOSURE

In one embodiment a forestry apparatus includes a main frame, a plurality of wheels or tracks configured to support the main frame from a ground surface, and a lifting linkage supported from the main frame. The lifting linkage includes a boom having a boom distal end portion. At least one lifting linkage actuator is configured to raise and lower the boom of the lifting linkage. A grapple is suspended from the boom distal end portion, the grapple including first and second grapple tongs and a grapple actuator configured to move the grapple tongs in a closing motion from an open position toward a closed position, the first and second grapple tongs having first and second grapple tong tips, respectively. At least one position sensor is configured to generate at least one position signal corresponding to positions of the first and second grapple tong tips relative to the main frame or relative to the ground surface. A controller is configured to receive the at least one position signal and to automatically control the at least one lifting linkage actuator to coordinate the positions of the first and second grapple tong tips relative to the main frame or relative to the ground surface with the closing motion of the grapple tongs.

In another embodiment a method is provided of automatically controlling the forestry apparatus including the set of grapple tongs suspended from the height adjustable boom, the method comprising: (a) detecting with at least one position sensor a position of lower tong tips of the set of grapple tongs relative to the ground surface and generating a position signal corresponding to the position of the lower tong tips relative to the ground surface; (b) receiving the position signal with the controller; (c) receiving with the controller a closing command from an operator to close the set of grapple tongs to grasp the article lying on the ground surface; and (d) during the closing of the set of grapple tongs, automatically controlling a height of the height adjustable boom with the controller at least in part in response to the detected position of the lower tong tips and thereby raising a height of the lower tong tips relative to the ground surface to reduce any digging of the lower tong tips into the ground surface as the grapple tongs grasp the article lying on the ground surface.

Numerous objects, features and advantages of the present invention will be readily apparent to those skilled in the art upon a review of following description in conjunction with the accompanying drawings.

### BRIEF DESCRIPTION OF THE DRAWINGS

FIG. 1 is a perspective view of a forestry apparatus in the form of a skidder grapple machine incorporating the present disclosure.

FIG. 2 is a side elevation view of the skidder grapple machine of FIG. 1.

FIG. 3 is an enlarged perspective cutaway view of a slip ring rotational joint between the boom and the grapple of the skidder grapple machine of FIG. 1.

FIG. 4 is a schematic diagram showing the geometry of the grapple tongs as they are moved between an open position and a closed position.

FIG. 5 is a schematic diagram of the controller of the skidder grapple machine with various signal inputs from the sensors of the machine and various command output signals to the actuators of the machine.

FIG. 6 is a side elevation view of a forestry apparatus in the form of a forwarder machine incorporating the present disclosure.

### DETAILED DESCRIPTION

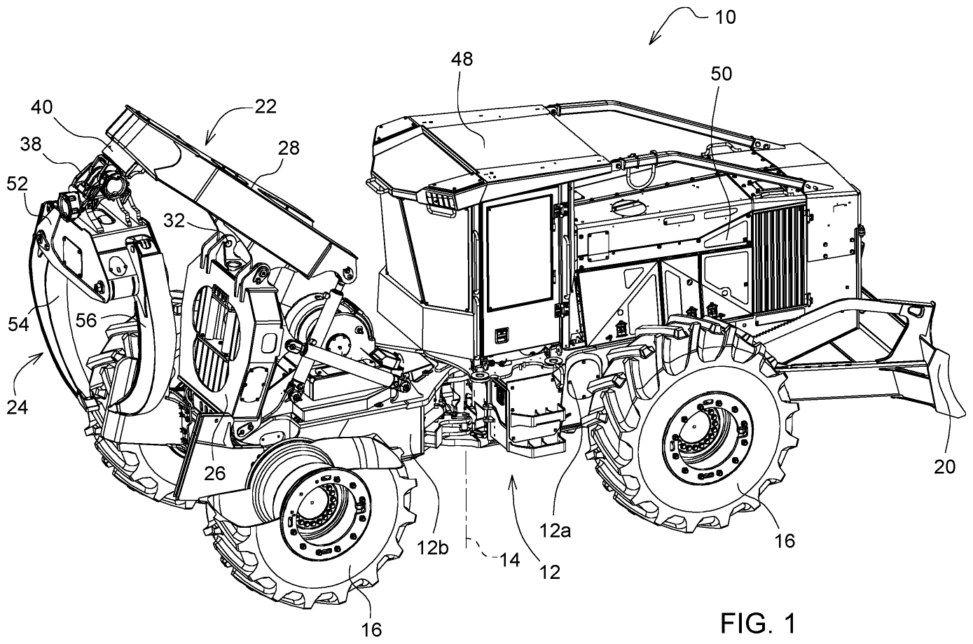

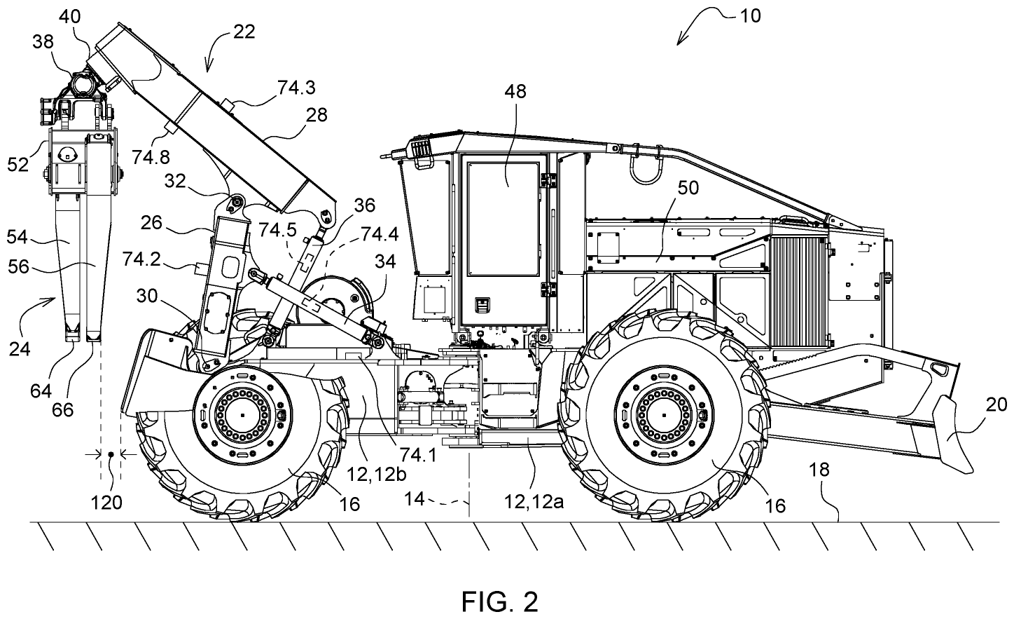

### The Embodiment of FIGS. 1-4: A Skidder Grapple Machine

Referring now to the drawings and particularly to FIG. 1, a skidder grapple machine or skidder grapple apparatus is generally designated by the number 10. The machine 10 includes an articulated main frame 12 including a forward frame portion 12a and a rearward frame portion 12b articulated about a vertical pivot axis 14. A plurality of ground engaging units 16 support the main frame 12 from a ground surface 18 and propel the machine 10 over the ground surface 18. The ground engaging units 16 are shown as wheels 16 but may also be in the form of tracks.

A dozer blade 20 is mounted on the front end of the forward frame portion 12a. A lifting linkage 22 and a grapple 24 are mounted on the rearward frame portion 12b.

The lifting linkage 22 includes an lower link 26 and a boom 28. In the context of a skidder grapple machine the lower link 26 is commonly referred to as an arch 26. The arch 26 is pivotably connected to the rearward frame portion 12b at pivotal connection 30. The boom 28 is pivotally connected to the arch 26 at pivotal connection 32. A pair of lower link actuators 34, which may also be referred to as arch actuators 34, in the form of hydraulic cylinders, adjust the pivotable position of the arch 26 relative to the rearward frame portion 12b, and a pair of boom actuators 36, also in the form of hydraulic cylinders, adjust the pivotable position of the boom 28 relative to the arch 26. The arch actuators 34 and the boom actuators 36 may collectively be referred to as lifting linkage actuators 34, 36 configured to raise and lower the boom 28 of the lifting linkage 22 relative to the main frame 12.

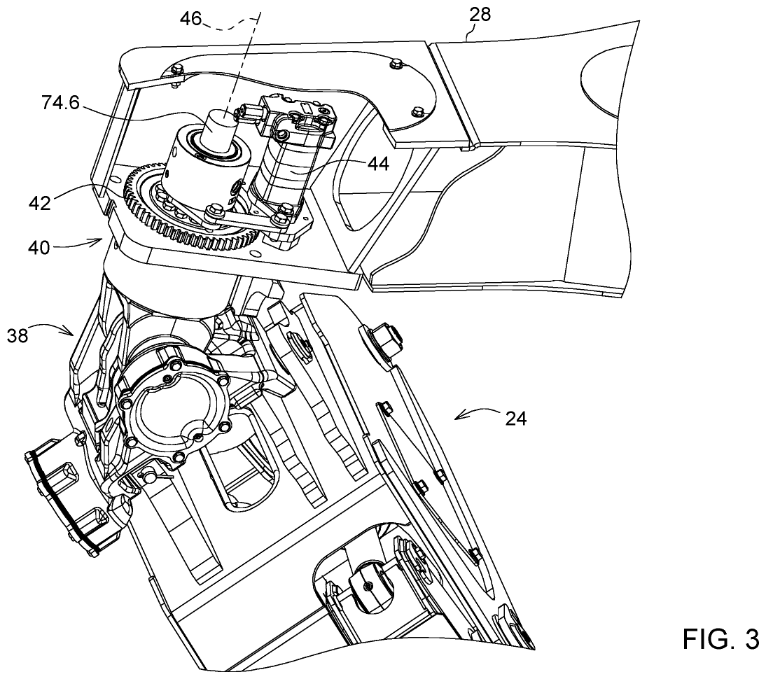

The grapple 24 is suspended from a universal joint 38 which is in turn connected to a distal end portion of the boom 28 by a pivotal connection 40 in a form sometimes referred to as a slip ring 40. As is best seen in FIG. 3 the slip ring 40 includes a slip ring gear 42 driven by a motor 44 to rotate the universal joint 38 and the grapple 24 about a slip ring axis 46 relative to the distal end portion of the boom 28.

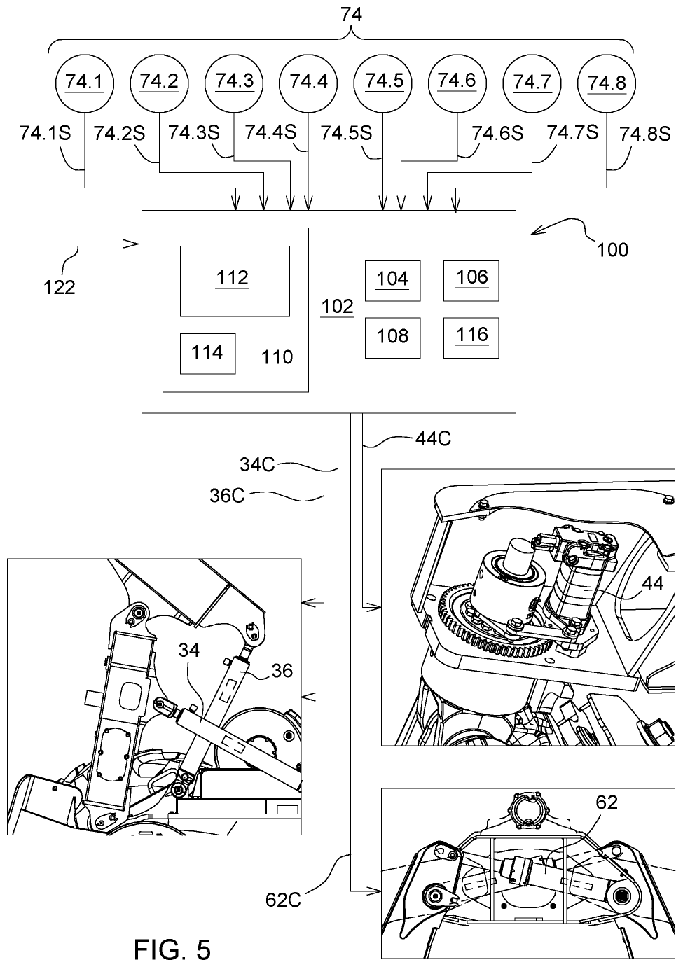

An operator's cabin 48 may be located on the forward frame portion 12a of main frame 12. A human operator in the cabin 48 may direct the operation of the machine 10 via a control system 100 further described below with reference to FIG. 5. Power for the operation of the machine 10 may be provided by a power source 50 located on the forward frame portion 12a.

In one embodiment the power source 50 may be an internal combustion engine 50. The internal combustion engine may drive a hydraulic pump arrangement to provide hydraulic power to the various actuators and to drive the wheels 16. In this embodiment the various actuators and motors may be hydraulically powered.

In another embodiment the power source 50 may be an electrical power source such as a battery 50, and in such embodiment the various actuators and motors may be electrically powered. Combinations of hydraulically powered components and electrically powered components may also be used.

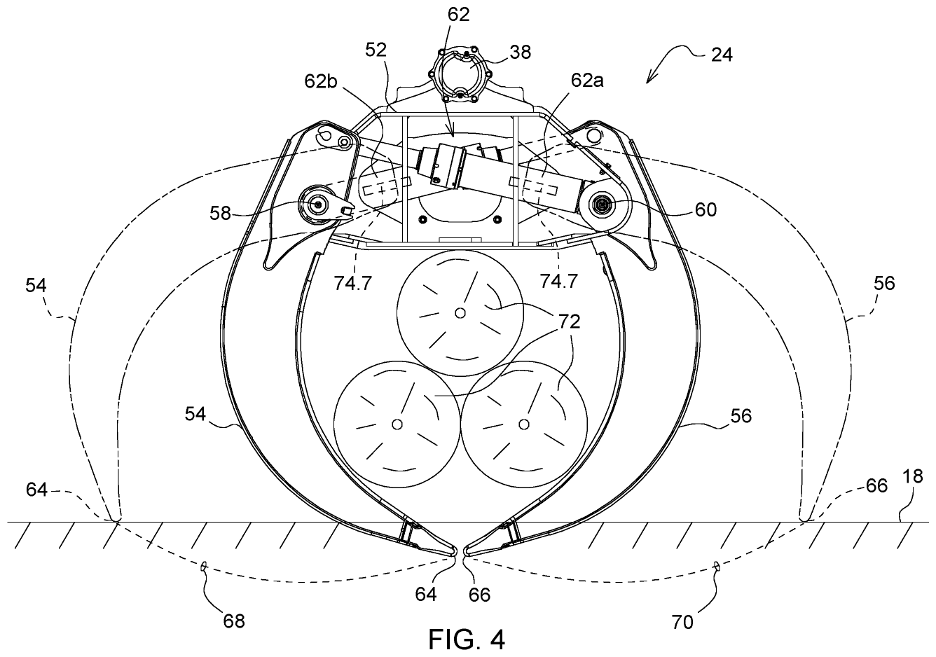

As schematically shown in FIG. 4, grapple 24 may include a grapple head 52 connected to the universal joint 38. First and second grapple tongs 54 and 56 are pivotally connected to the grapple head 52 at pivot joints 58 and 60. A grapple actuator 62 may be configured to move the grapple tongs 54 and 56 relative to the grapple head 52 and to each other between an open position shown in dash lines in FIG. 4 and a closed position shown in solid lines in FIG. 4. As schematically shown in FIG. 4, the grapple actuator 62 may include first and second hydraulic cylinders 62a and 62b connected between the grapple head 52 and the first and second grapple tongs 54 and 56, respectively.

The first and second grapple tongs 54 and 56 include lower tong tips 64 and 66, respectively. As can be seen in the schematic view of FIG. 4 the tong tips 64 and 66 move through arcuate paths 68 and 70 about the pivot joints 58 and 60 and thus a vertical height of the tong tips 64 and 66 relative to the main frame 12 and relative to the ground surface 18 varies as the tongs 54 and 56 are moved between their open and closed positions.

One problem addressed by the present invention is the control of the location of the tong tips 64 and 66 relative to the ground surface 18 as the tongs 54 and 56 are moved in a closing motion, such as from the dashed line open position of FIG. 4 toward the solid line closed position of FIG. 4 to grasp a load 72 lying on the ground surface. The load 72 may for example be a stack of logs which have been cut and need to be moved to a different location. As can be seen in FIG. 4, if the tong tips 64 and 66 are initially placed at or near the ground surface 18 in an open position, and if the tongs are then moved in a closing motion toward the solid line closed position without any adjustment of the height of the boom 28 which is supporting the grapple 24, the arcs 68 and 70 of movement of the tong tips 64 and 66 will pass downward below the ground surface 18 and through the ground material.

The present disclosure describes a system which automatically monitors the position of the tong tips 64 and 66 relative to the ground surface 18 and controls the height of the boom 28 during a closing motion of the tongs 54 and 56, so that the height of the boom 28 and of the tong tips 64 and 66 is coordinated with the closing motion of the tongs 54 and 56 such that the grapple tong tips 64 and 66 substantially follow the profile of the ground surface 18 during the closing motion of the tongs 54 and 56. This reduces digging of the grapple tong tips 64 and 66 into the ground surface 18 during the closing motion.

At least one position sensor 74 is configured to generate at least one position signal corresponding to the positions of the first and second grapple tong tips 64 and 66 relative to the main frame 12 or to the ground surface 18.

In one embodiment the at least one position sensor 74 may include a frame position sensor 74.1 configured to detect a position of the rearward portion 12b of the main frame 12 relative to the ground surface. The frame position sensor 74.1 may for example be an Inertial Measurement Unit (IMU) mounted on the rearward frame portion 12b.

The at least one position sensor 74 may further include at least one linkage position sensor configured to detect a kinematic position of the boom 28 relative to the rearward portion 12b of the main frame 12. The at least one linkage position sensor may include an arch position sensor 74.2 and a boom position sensor 74.3. In one embodiment the arch position sensor 74.2 and the boom position sensor 74.3 may each also be an IMU.

In another embodiment the arch actuators 34 (or one of the arch actuators 34) and the boom actuators 36 (or one of the boom actuators 36) may each include a smart hydraulic cylinder including an integrated extension sensor. In FIG. 4 the integrated extension sensor of the arch actuator 34 is indicated schematically as 74.4 and the integrated extension sensor of the boom actuator 36 is indicated schematically as 74.5. It will be understood that the extension of the respective extension sensors 74.4 and 74.5 will correspond to the angular position of the arch 26 about its pivot axis 30 and of the boom 28 about its pivot axis 32.

Given the known geometry of the lifting linkage 22, the data from the sensors 74.2 and 74.3 or the data from the sensors 74.4 and 74.5 can be used to determine the position of the distal end portion of the boom 28 relative to the rearward frame portion 12b. And knowing the position of the rearward frame portion 12b relative to the ground surface 18 from sensor 74.1, the position of the distal end portion of the boom 28 relative to the ground surface can be determined.

The at least one position sensor 74 may further include at least one grapple tong position sensor configured to determine the position of the grapple tongs 54 and 56, and particularly the position of the tong tips 64 and 66, in their closing motion. This will provide the position of the tong tips 64 and 66 relative to the boom 28, and thus the position of the tong tips 64 and 66 relative to the rearward frame portion 12b and/or to the ground surface 18 may be determined.

In one embodiment the at least one grapple tong position sensor may further include a rotational position sensor 74.6 associated with the slip ring 40 for determining a rotational position of the universal joint 38 and thus of the grapple 24 about the rotational axis 46.

The at least one grapple tong position sensor may further include an extension sensor 74.7 associated with one or both of the grapple actuators 62a and 62b. The grapple actuators 62a and 62b may be embodied as smart hydraulic cylinders having the extension sensors 74.7 integrally formed therein, and the position of the extension sensors 74.7 will correspond to the position of the tong tips 64 and 66 along their arc paths 68 and 70. Alternatively to the extension sensors 74.7 may be rotational sensors placed at the pivot points 58 and 60.

In another embodiment, instead of instrumenting the grapple 24 with the sensors 74.6 and 74.7, a further grapple tong position sensor 74.8 in the form of a camera 74.8 may be mounted on the boom 28 and focused on the grapple 24 so that the camera 74.8 is configured to detect the positions of the tong tips 64 and 66 relative to the ground surface 18. By orienting the camera 74.8 to view both the tong tips 64,66 and the ground surface 18 below the tong tips, and through the use of appropriate image processing by the controller 102, the camera 74.8 can directly detect the vertical height of the tong tips 64, 66 relative to the ground surface 18.

### Control System:

As schematically illustrated in FIG. 5, the machine 10 includes a control system 100 including a controller 102. The controller 102 may be part of the machine control system of the grapple skidder apparatus 10, or it may be a separate control module. The controller 102 may for example be mounted in a control panel located at the operator's station 48. Controller 102 is configured to receive input signals from the various sensors. The signals transmitted from the various sensors to the controller 102 are schematically indicated in FIG. 5 by lines connecting the sensors to the controller with an arrowhead indicating the flow of the signal from the sensor to the controller 102.

For example, position signal 74.1S from position sensor 74.1 may be received by controller 102 indicative of a pitch and roll orientation of the rearward frame portion 12b relative to the ground surface 18.

Position signals 74.2S and 74.3S from IMU's 74.2 and 74.3 may be received by controller 102 representative of the positions of the arch 26 and boom 28. Alternatively, position signal 74.4S may be received by controller 102 representative of an extension of smart hydraulic cylinder 34 and thus of the angular position of arch 26 relative to the rearward frame portion 12b, and position signal 74.5S may be received by the controller 102 representative of an extension of the smart hydraulic cylinder 36 and thus of the angular position of boom 28 relative to the arch 26.

Position signals 74.6S and 74.7S may be received from the rotational sensor 74.6 and the extension sensor 74.7, thus representing the position of the tong tips 64 and 66 relative to the distal end portion of the boom 28. Alternatively, a position signal 74.8S may be received from the camera sensor 74.8 representing the position of the tong tips 64 and 66 relative to the distal end portion of the boom 28. The position signal 74.8S may also directly represent the height of the tong tips 64, 66 relative to the ground surface 18.

Similarly, the controller 102 will generate control signals for controlling the operation of the various actuators discussed above, which control signals are indicated schematically in FIG. 5 by lines connecting the controller 102 to graphic depictions of the various actuators with the arrow indicating the flow of the command signal from the controller 102 to the respective actuators. It will be understood that for control of a hydraulic cylinder type actuator, such as the hydraulic smart cylinders 34, 36, 62a, and 62b, or for control of a hydraulic motor type actuator such as motor 44, the controller 102 will send an electrical signal to an electro/mechanical control valve which controls flow of hydraulic fluid from a pump to the hydraulic actuator and from the hydraulic actuator back to a hydraulic storage tank.

For example, the controller 102 may send command signal 34C to control the arch actuators 34, control signal 36C to control the boom actuators 36, control signal 44C to control the drive motor 44 for slip ring 40, and control signal 62C to control the grapple actuators 62a, 62b.

As is further explained below the controller 102 may receive at least one of the position signals 74.1S-74.8S and may automatically control at least one of the actuators 34 and 36 of the lifting linkage 22 to coordinate the positions, and particularly the heights, of the first and second grapple tong tips 64 and 66 relative to the rearward main frame portion 12b, or relative to the ground surface 18, with the closing motion of the grapple 24. It will be appreciated that each of the position signals 74.1S-74.8S correspond at least in part to the positions of the grapple tong tips 64 and 66 relative to the rearward main frame portion 12b and/or relative to the ground surface 18.

Controller 102 includes or may be associated with a processor 104, a computer readable medium 106, a data base 108 and an input/output module or control panel 110 having a display 112. An input/output device 114, such as a keyboard, joystick or other user interface, is provided so that the human operator may input instructions to the controller. It is understood that the controller 102 described herein may be a single controller having all of the described functionality, or it may include multiple controllers wherein the described functionality is distributed among the multiple controllers.

Various operations, steps or algorithms as described in connection with the controller 102 can be embodied directly in hardware, in a computer program product 116 such as a software module executed by the processor 104, or in a combination of the two. The computer program product 116 can reside in RAM memory, flash memory, ROM memory, EPROM memory, EEPROM memory, registers, hard disk, a removable disk, or any other form of computer-readable medium 106 known in the art. An exemplary computer-readable medium 106 can be coupled to the processor 104 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The data storage in computer readable medium 106 and/or database 108 may in certain embodiments include a database service, cloud databases, or the like. In various embodiments, the computing network may comprise a cloud server, and may in some implementations be part of a cloud application wherein various functions as disclosed herein are distributed in nature between the computing network and other distributed computing devices. Any or all of the distributed computing devices may be implemented as at least one of an onboard vehicle controller, a server device, a desktop computer, a laptop computer, a smart phone, or any other electronic device capable of executing instructions. A processor (such as a microprocessor) of the devices may be a generic hardware processor, a special-purpose hardware processor, or a combination thereof.

During operation of the skidder grapple machine 10 under direction of a human operator located in the operator's cabin 48 the human operator will drive the machine 10 to the vicinity of a load 72 to be transported. The human operator may control the machine 10 through various inputs to controller 102 via the input/output device 114 which may for example be a combination of joystick and button controls. The human operator will control the arch actuators 34 and boom actuators 36 to place the grapple 24 over the load 72. The human operator will direct the grapple actuators 62a, 62b to an open position like that shown in FIG. 4 and will direct the arch actuators 34 and/or the boom actuators 362 to lower the grapple 24 into a position like the dashed line position of FIG. 4 over the load 72. The human operator may direct the motor 44 to rotate the grapple 24 about the slip ring axis 46 to properly orient the grapple 24 relative to the load 72. At all times the controller 102 can determine the location of the grapple tong tips 64, 66 relative to the ground surface 18 by the position signals 74.1S-74.8S from one or more of the position sensors 74.1-74.8.

When the human operator inputs a closing command 122, schematically represented by arrow 122 in FIG. 4, directing the closing motion of the grapple tongs 54 and 56 from the open dashed line position of FIG. 4 towards the closed solid line position of FIG. 4, the controller 102 may take that closing command 122 as a trigger signal to implement an automatic boom height control mode to coordinate the height of the tong tips 64 and 66 relative to the ground surface with the closing motion such that the grapple tong tips 64 and 66 substantially follow the profile of the ground surface 18 during the closing motion. This may be done by sending the appropriate command signals 34C and/or 36C to raise the boom 28 using the arch actuators 34 and/or the boom actuators 36.

The automatic boom height control mode just described allows the human operator to focus on the primary job of grasping the load 72, while the controller 102 will automatically control the height of the boom 28 and thus of the grapple 24 relative to the ground surface so that the grapple tong tips 64 and 66 will skim across or just above the ground surface 18 as they close around the load 72.

The automatic boom height control mode can be described as a method of automatically controlling the skidder grapple apparatus 10 including the set of grapple tongs 54, 56 suspended from the height adjustable boom 28, comprising: (a) detecting with at least one position sensor 74.1-74.8 a position of lower tong tips 64, 66 of the set of grapple tongs 54, 56 relative to the ground surface 18 and generating a position signal 74.1S-74.8S corresponding to the position of the lower tong tips 64, 66 relative to the ground surface 18; (b) receiving the position signal 74.1S-74.8S with the controller 102; (c) receiving with the controller 102 the closing command 122 from an operator to close the set of grapple tongs 54, 56 to grasp the article 72 lying on the ground surface 18; and (d) during the closing of the set of grapple tongs 54, 56, automatically controlling a height of the height adjustable boom 28 with the controller 102 at least in part in response to the detected position of the lower tong tips 64, 66 and thereby raising a height of the lower tong tips 64, 66 relative to the ground surface 18 to reduce any digging of the lower tong tips 64, 66 into the ground surface 18 as the grapple tongs 54, 56 grasp the article 72 lying on the ground surface 18.

Step (a) may further include detecting with at least one of the boom position sensors 74.1-74.5 the height of the distal end portion of the height adjustable boom 28 relative to the rearward main frame portion 12b, and detecting with at least one of the grapple position sensors 74.6-74.8 a position of the lower tong tips 64, 66 relative to the distal end portion of the height adjustable boom 28.

Step (a) may still further include detecting with the frame pitch and roll sensor 74.1 an orientation of the rearward main frame portion 12b relative to the ground surface 18.

Step (d) may further include automatically controlling with the controller 102 the pivotal position of the pivoted arch 26 about pivot axis 30 relative to the rearward main frame portion 12b, and automatically controlling with the controller 102 the pivotal position of the height adjustable boom 28 about pivot axis 32 relative to the pivoted arch 26.

Although the grapple 24 is shown in FIG. 4 in the ideal vertical orientation with the two tong tips 64, 66 moving in synchronized fashion from their open position to their closed position, it will be appreciated that there are circumstances where the movement of the tongs may not be synchronized or where the grapple 24 may be tilted. For example, the movement of the tongs may not be synchronized due to inertia or due to disproportionate flow rates to the tong actuator cylinders 62a, 62b. Or the grapple 24 may be tilted at the time of its landing on the pile of logs 72 due to its engagement with an asymmetric log pile.

In the disclosed embodiment where each of the tong actuator cylinders 62a, 62b includes an individual extension sensor 74.7, the controller 102 can detect unsynchronized movement of the tong tips 64, 66 and correct that movement by separately commanding each of the tong actuator cylinders 62a, 62b. The controller 102 may command a lagging tong actuator to speed up its closing motion. The controller 102 may synchronize the closing motion of the tong tips 64, 66 before carrying out the height adjustment described above. Alternatively, the controller 102 may adjust the height of the boom 28 with respect to the position of one tong tip 64 or 66 and then adjust the tong position of the other tong tip.

The controller 102 may also detect a tilted orientation of the grapple 24. This may be done using the camera-based sensor 74.8 or any other tilt sensor such as an inclinometer or IMU. Alternatively, the universal joint 38 may be instrumented with rotational position sensors on each of its pivotal axes. In either embodiment, the controller 102 may take into consideration the orientation of the grapple 24 when adjusting the height of the boom 28 to control the position of one or both of the tong tips 64, 66 relative to the ground surface 18.

In a further enhancement of the process, the controller 102 may automatically control the lateral position of the grapple 24 relative to the rearward main frame portion 12b by selectively using the arch actuators 34 and boom actuators 36 to achieve the desired change in height of the boom 28. This may be described as automatically coordinating the pivotable position of the pivoted arch 26 relative to the main frame 12 with the pivotable position of the height adjustable boom 28 relative to the pivoted arch 26, so as to maintain a substantially constant lateral distance 120 of the grapple tongs 24 from the main frame 12 while adjusting the height of the height adjustable boom 28 relative to the main frame 12. This is a function which is very difficult for a human operator to achieve while controlling boom height manually.

Many advantages are provided by the system described above. The automation of the control of grapple tong height relative to the ground surface can improve the operator's turnaround time for engaging the load 72.

The automation of the control of grapple tong height relative to the ground surface can reduce operator fatigue by eliminating the need for the operator to deal with boom tip adjustment.

The automation of the control of grapple tong height relative to the ground surface is an important building block for developing a remotely operated or autonomous grapple skidder.

The automation of the control of grapple tong height relative to the ground surface may help in maximizing the payload that can be handled by the grapple skidder.

Prevention of the tongs from digging into the ground surface during closing can reduce wear and tear on the tongs, and especially on the tong tips 64, 66.

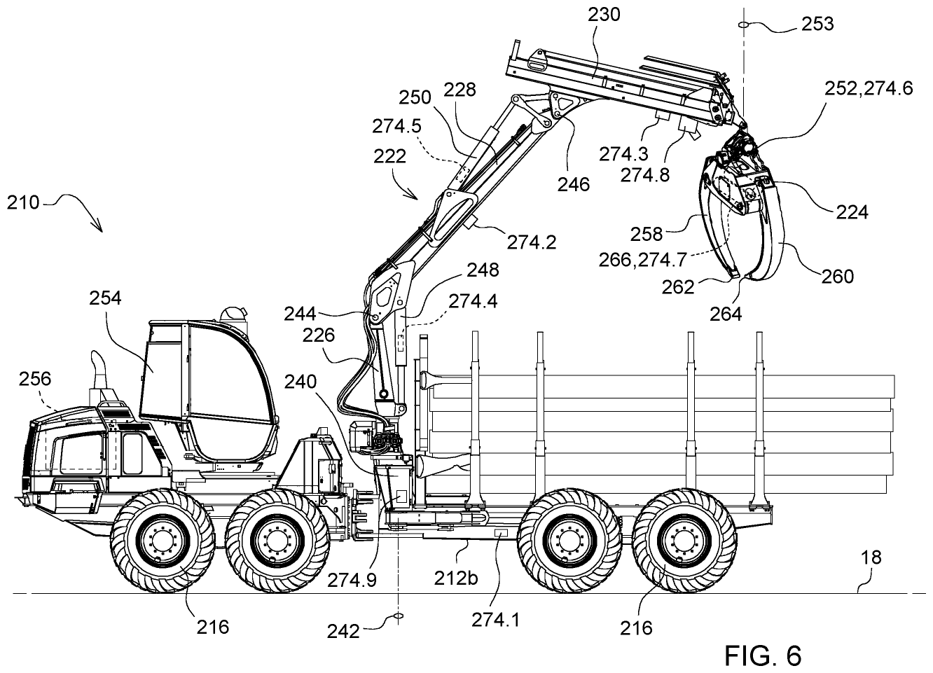

### Embodiment of FIG. 6-a Forwarder Machine

Referring now to FIG. 6, a forestry machine in the form of a forwarder machine is shown and generally designated by the number 210. A forwarder machine is used to load logs into a wagon of the forwarder and transport those logs to a different location where the logs are off loaded for further processing.

The forwarder machine 210 includes an articulated main frame 212 including a forward frame portion 212a and a rearward frame portion 212b articulated about a vertical pivot axis 214. The rearward frame portion 212b may define a load space or wagon. A plurality of ground engaging units 216 support the main frame 12 from a ground surface 18 and propel the machine 210 over the ground surface 18. The ground engaging units 216 are shown as wheels 216 but may also be in the form of tracks.

A lifting linkage 222 and a grapple 224 are mounted on the rearward frame portion 212b. The lifting linkage 222 includes a post 226, a lower link 228, and a boom 230. In the context of a forwarder machine 210 the lower link 228 is sometimes referred to as jib boom or hoisting boom 228, and the boom 230 is sometimes referred to as a knuckle boom or extension boom 230. The boom 230 may be extendible in a telescoping fashion along its length. The post 226 is mounted on a slewing table 240 which is mounted on the rearward frame portion 212b so that the entire lifting linkage 222 can be slewed or rotated about a vertical axis 242 relative to the rearward frame portion 212b. The lower link 228 is pivotably connected to the post 226 at pivotal connection 244. The boom 230 is pivotally connected to the lower link 228 at pivotal connection 246. A lower link actuator 248 in the form of a hydraulic cylinder adjusts the pivotable position of the lower link 228 relative to the post 226 and the rearward frame portion 212b. A boom actuator 250, also in the form of a hydraulic cylinder, adjusts the pivotable position of the boom 230 relative to the lower link 228.

The lower link actuator 248 and the boom actuator 250 may collectively be referred to as lifting linkage actuators 248, 250 configured to raise and lower the boom 230 of the lifting linkage 222 relative to the main frame 212.

The grapple 224 is suspended from a powered rotary joint 252 which is in turn connected to an distal end portion of the boom 230.

An operator's cabin 254 may be located on the forward frame portion 212a of main frame 212. A human operator in the cabin 254 may direct the operation of the machine 210 via a control system like the control system 100 described above with reference to FIG. 5. Power for the operation of the machine 10 may be provided by a power source 256 located on the forward frame portion 212a.

The grapple 224 includes first and second grapple tongs 258 and 260 having lower tong tips 262 and 264. A grapple actuator 266 opens and closes the grapple tongs. The forwarder machine 210 encounters the same problem as described above for the skidder grapple machine 10, in that when its grapple 224 is used to pickup a log off the ground surface 18 the tong tips 262 and 264 may dig into the ground surface.

The present disclosure describes a system which automatically monitors the position of the tong tips 262 and 264 relative to the ground surface 18 and controls the height of the boom 230 during a closing motion of the tongs 258 and 260, so that the height of the boom 230 and of the tong tips 262 and 264 is coordinated with the closing motion of the tongs 258 and 260 such that the grapple tong tips 262 and 264 substantially follow the profile of the ground surface 18 during the closing motion of the tongs 258 and 260. This reduces digging of the grapple tong tips 262 and 264 into the ground surface 18 during the closing motion.

One difference which may be encountered in implementing such a control system in a forwarder machine 210, as compared to the skidder grapple machine 10 is that in a forwarder machine 210 the control command for the opening and closing of the grapple 224 may be a simple fully open or fully closed command. That is contrasted to the typical control command for the skidder grapple machine 10 in which an incremental closing command may be used. Also the physical size of the grapple 224 is typically much smaller than that of the grapple 24 of the skidder grapple machine 10. Due to the smaller size of the grapple 224 it is possible to estimate the position of the tong tips 262 and 264 relative to the ground surface 18 based on the known physical dimensions of the tongs 258 and 260 and based on the knowing whether the tongs are fully open or fully closed. Alternatively, the grapple 252 may utilize incremental closing commands like the grapple 24.

At least one position sensor 274 is configured to generate at least one position signal corresponding to the positions of the first and second grapple tong tips 262 and 264 relative to the rearward frame portion 212b or to the ground surface 18.

In one embodiment the at least one position sensor 274 may include a frame position sensor 274.1 configured to detect a position of the rearward portion 212b of the main frame 212 relative to the ground surface 18. The frame position sensor 274.1 may for example be an Inertial Measurement Unit (IMU) mounted on the rearward frame portion 212b.

The at least one position sensor 274 may further include at least one linkage position sensor configured to detect a kinematic position of the boom 230 relative to the rearward portion 212b of the main frame 212. The at least one linkage position sensor may include a lower link position sensor 274.2 and a boom position sensor 274.3. In one embodiment the lower link position sensor 274.2 and the boom position sensor 274.3 may each also be an IMU.

In another embodiment the lower link actuator 248 and the boom actuator 250 may each include a smart hydraulic cylinder including an integrated extension sensor. In FIG. 6 the integrated extension sensor of the lower link actuator 248 is indicated schematically as 274.4 and the integrated extension sensor of the boom actuator 250 is indicated schematically as 274.5. It will be understood that the extension of the respective extension sensors 274.4 and 274.5 will correspond to the angular position of the lower link 228 about its pivot axis 244 and of the boom 230 about its pivot axis 246.

The at least one position sensor 274 may further include a rotary position sensor 274.9 associated with the slewing table 240 and configured to detect a rotational position of the lifting linkage 222 about axis 242 relative to the rearward frame portion 212b.

Given the known geometry of the lifting linkage 222, the data from sensor 274.9 and the data from the sensors 274.2 and 274.3 or the data from the sensors 274.4 and 274.5 can be used to determine the position of the distal end portion of the boom 230 relative to the rearward frame portion 212b. And knowing the position of the rearward frame portion 212b relative to the ground surface 18 from sensor 274.1, the position of the distal end portion of the boom 230 relative to the ground surface 18 can be determined.

The at least one position sensor 274 may further include at least one grapple tong position sensor configured to determine the position of the grapple tongs 258 and 260, and particularly the position of the tong tips 262 and 264, in their closing motion. This will provide the position of the tong tips 262 and 264 relative to the boom 230, and thus the position of the tong tips 262 and 264 relative to the rearward frame portion 212b and/or to the ground surface 18 may be determined.

In one embodiment the at least one grapple tong position sensor may further include a rotational position sensor 274.6 associated with the powered rotary joint 252 for determining a rotational position of the grapple 224 about the rotational axis 253 of the powered rotary joint 252.

The at least one grapple tong position sensor may further include an extension sensor 274.7 associated with one the grapple actuator 266. The grapple actuator 266 may be embodied as a smart hydraulic cylinder having the extension sensor 274.7 integrally formed therein, and the position of the extension sensor 274.7 will correspond to the position of the tong tips 262 and 264 along their arc paths. Alternatively to the extension sensor 274.7, rotational sensors may be placed at the pivot points of the grapple tongs.

In another embodiment, instead of instrumenting the grapple 224 with the sensors 274.6 and 274.7, a further grapple tong position sensor 274.8 in the form of a camera 274.8 may be mounted on the boom 230 and focused on the grapple 224 so that the camera 274.8 is configured to detect the positions of the tong tips 262 and 264 relative to the ground surface 18. By orienting the camera 274.8 to view both the tong tips 262,264 and the ground surface 18 below the tong tips, and through the use of appropriate image processing by the controller, the camera 274.8 can directly detect the vertical height of the tong tips 262, 264 relative to the ground surface 18.

The controller 100 of FIG. 5 may also be configured to control the forwarder machine 210 of FIG. 6. The sensor inputs from the position sensors 274.1-274.9 may be used in place of the sensors 74.1-74.8, and the controller will send command signals to control the operation of the slewing table 240, the lower link actuator 248, the distal link actuator 250, the powered rotary joint 252, and the grapple actuator 266.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1: A forestry apparatus, comprising:
a main frame;
a plurality of wheels or tracks configured to support the main frame from a ground surface;
a lifting linkage supported from the main frame, the lifting linkage including a boom having a boom distal end portion;
at least one lifting linkage actuator configured to raise and lower the boom of the lifting linkage;
a grapple suspended from the boom distal end portion, the grapple including first and second grapple tongs and a grapple actuator configured to move the grapple tongs in a closing motion from an open position toward a closed position, the first and second grapple tongs having first and second grapple tong tips, respectively;
at least one position sensor configured to generate at least one position signal corresponding to positions of the first and second grapple tong tips relative to the main frame or relative to the ground surface; and
a controller configured to receive the at least one position signal and to automatically control the at least one lifting linkage actuator to coordinate the positions of the first and second grapple tong tips relative to the main frame or relative to the ground surface with the closing motion of the grapple tongs.

2: The forestry apparatus of claim 1, wherein:
the controller is configured to coordinate the positions of the first and second grapple tong tips relative to the main frame or relative to the ground surface with the closing motion of the grapple tongs such that the grapple tong tips substantially follow a ground profile of the ground surface during the closing motion of the grapple tongs.

3: The forestry apparatus of claim 1, wherein:
the controller is further configured to send command signals to the at least one lifting linkage actuator to adjust a height of the boom during the closing motion of the grapple tongs to grasp a load lying on the ground surface, such that the grapple tong tips substantially follow a ground profile of the ground surface during the closing motion of the grapple tongs thereby reducing digging of the grapple tong tips into the ground surface during the closing motion of the grapple tongs.

4: The forestry apparatus of claim 1, wherein:
the lifting linkage includes a lower link pivotally mounted on the main frame;
the boom is pivotally mounted on the lower link; and
the at least one lifting linkage actuator includes a lower link actuator configured to pivot the lower link relative to the main frame and a boom actuator configured to pivot the boom relative to the lower link.

5: The forestry apparatus of claim 4, wherein the at least one position sensor includes:
a frame position sensor configured to detect a position of the main frame relative to the ground surface; and
at least one linkage position sensor configured to detect a kinematic position of the boom relative to the main frame.

6: The forestry apparatus of claim 5, wherein:
the frame position sensor includes an inertial measurement unit.

7: The forestry apparatus of claim 5, wherein:
the at least one linkage position sensor includes a lower link position sensor and a boom position sensor.

8: The forestry apparatus of claim 7, wherein:
the lower link position sensor and the boom position sensor each include a further inertial measurement unit.

9: The forestry apparatus of claim 7, wherein:
the lower link actuator and the boom actuator each include a smart hydraulic cylinder having an integrated extension sensor; and
the integrated extension sensors of the smart hydraulic cylinders of the lower link actuator and the boom actuator are the lower link position sensor and the boom position sensor, respectively.

10: The forestry apparatus of claim 5, wherein the at least one position sensor further includes:
at least one grapple tong position sensor configured to detect a closing position of the grapple tongs.

11: The forestry apparatus of claim 4, wherein:
the at least one position sensor includes at least one linkage position sensor configured to detect a kinematic position of the boom relative to the main frame; and
the controller is configured to send command signals to the lower link actuator and the boom actuator to coordinate lower link movement and boom movement so as to maintain a substantially constant lateral distance of the grapple from the main frame while adjusting a height of the boom relative to the main frame.

12: The forestry apparatus of claim 1, wherein:
the at least one position sensor includes a camera configured to detect the positions of the first and second grapple tong tips relative to the ground surface.

13: The forestry apparatus of claim 12, wherein:
the camera is mounted on the boom.

14: The forestry apparatus of claim 1, wherein:
the at least one position sensor includes a grapple tong position sensor operably associated with the grapple actuator and configured to detect a grapple tong position in a range from the open position to the closed position.

15: The forestry apparatus of claim 14, wherein:
the linkage assembly includes a rotational joint between the boom distal end portion and the grapple, the rotational joint having a rotational axis; and
the at least one position sensor further includes a rotational position sensor configured to detect a rotational position of the grapple relative to the boom distal end portion about the rotational axis.

16: A method of automatically controlling a forestry apparatus including a set of grapple tongs suspended from a height adjustable boom, comprising:
(a) detecting with at least one position sensor a position of lower tong tips of the set of grapple tongs relative to a ground surface and generating a position signal corresponding to the position of the lower tong tips relative to the ground surface;
(b) receiving the position signal with a controller;
(c) receiving with the controller a closing command from an operator to close the set of grapple tongs to grasp an article lying on the ground surface; and
(d) during the closing of the set of grapple tongs, automatically controlling a height of the height adjustable boom with the controller at least in part in response to the detected position of the lower tong tips and thereby raising a height of the lower tong tips relative to the ground surface to reduce any digging of the lower tong tips into the ground surface as the grapple tongs grasp the article lying on the ground surface.

17: The method of claim 16, wherein step (a) further comprises:
detecting with a boom position sensor a height of a distal end portion of the height adjustable boom relative to a main frame of the skidder grapple apparatus; and
detecting with a grapple position sensor a position of the lower tong tips relative to the distal end portion of the height adjustable boom.

18: The method of claim 17, wherein step (a) further comprises:
detecting with a frame pitch and roll sensor an orientation of the main frame relative to the ground surface.

19: The method of claim 16, wherein step (d) further comprises:
automatically controlling with the controller, a pivotable position of a pivoted lower link relative to a main frame of the forestry apparatus; and
automatically controlling with the controller, a pivotable position of the height adjustable boom relative to the pivoted lower link.

20: The method of claim 19, further comprising:
automatically coordinating the pivotable position of the pivoted lower link relative to the main frame with the pivotable position of the height adjustable boom relative to the pivoted lower link, so as to maintain a substantially constant lateral distance of the grapple tongs from the main frame while adjusting the height of the height adjustable boom relative to the main frame.
